(19) United States
(12) Patent Application Publication
(10) Pub. No.: US 2016/0055740 A1
(43) Pub. Date: Feb. 25, 2016

(54) SYSTEMS AND METHODS FOR MEDICAL DEVICE LOCATION DISCOVERY

(71) Applicant: Mindray DS USA, Inc., Mahwah, NJ (US)

(72) Inventors: Kenneth J. Fuchs, Wayland, MA (US); Scott K. Eaton, Briarcliff Manor, NY (US)

(21) Appl. No.: 14/467,977

(22) Filed: Aug. 25, 2014

(51) Int. Cl. G08B 21/24

(52) U.S. Cl. CPC G08B 21/24

(57) ABSTRACT

Medical monitoring devices may be able to read a wireless tag and determine its location based on the information read from the tag. The tag may be an RFID tag, a barcode, etc. The tag may itself include the location, or the tag may include an identifier that allows the location to be retrieved from a remote storage device via a network. The medical monitoring device may also be able to retrieve configuration information using the identifier. The configuration information may be location specific but can be modified for every associated tag by updating the remote storage device. The configuration information may include settings for the medical monitoring devices and/or may include destinations for physiological data measured by the medical monitoring devices.

### TECHNICAL FIELD

The present disclosure relates to medical monitoring devices and more particularly relates to systems and methods that enable such devices to automatically discover their location.

### BRIEF DESCRIPTION OF THE DRAWINGS

FIG. 1 is a perspective view of an embodiment of a medical practitioner reading a tag using a patient monitor.

FIG. 2 is a perspective view of an alternate embodiment of a patient monitor configured to read a tag.

FIG. 3 is a block diagram of a system for configuring a patient monitor based on location.

FIG. 4 is a perspective view of a patient monitor presenting an exemplary screen display that may be provided to the user for selecting a wireless reader to read a tag.

FIG. 5 is a perspective view of a patient monitor presenting an exemplary screen display that may be provided to a user for selecting which information should be retrieved.

FIG. 6 is a perspective view of a patient monitor presenting an exemplary screen display confirming that a tag should be read.

FIG. 7 is a flow diagram of a method for discovering a location of a medical monitoring device.

### DETAILED DESCRIPTION OF PREFERRED EMBODIMENTS

Modern medical practice makes extensive use of electronic monitoring of vital signs and other physiological parameters of patients. A medical monitoring device may include one or more sensors to acquire physiological data representative of the physiological condition of the patient. Medical monitoring devices may include patient monitors that display measurement data locally, telemetry devices that transmit measurement data to remote systems, and/or the like. Medical monitoring devices may need to be configured differently for different patients, hospital wards, and/or users. Thus, when a medical monitoring device moves with a patient from one ward to another, the medical monitoring device may need updated settings. Traditionally, each medical monitoring device would have to be configured manually for each new patient or location. The devices were prone to being misconfigured due to operator error, which could result in adverse outcomes for patients. For example, a misconfigured monitoring device may fail to issue an alert at the proper time, resulting in necessary care for a patient being delayed or even neglected entirely.

Medical monitoring devices may be configured based on their location (e.g., a bedside or bed, a room, etc. where the device is located). For example, a medical monitoring device may be able to determine its location and load configuration information corresponding to the location. In an embodiment, a medical monitoring device may identify its location by receiving an identifier corresponding to the location from a docking station. Alternatively, or in addition, the medical monitoring device may receive an indication of the location from the docking station. For the medical monitoring device to identify its location anywhere in a medical center, each room or bed in the medical center may need to have one or more docking stations. It may be expensive for a medical center to acquire the necessary number of medical monitoring devices (e.g., the expense of acquiring a docking station for each bedside). The medical center also may be restricted to only buying a single kind or limited selection of medical monitoring devices.

In another embodiment, the medical monitoring device may be configured to read a tag that is independent of and/or unassociated with any docking stations. The medical monitoring device may not need to mechanically couple with the tag. Rather, it may read the tag as long as it is in close proximity to the tag. The tag may include only the components necessary for the medical monitoring device to read the tag. The tags may be inexpensive to manufacture and install throughout the medical center. Additionally, different kinds and/or makes of medical monitoring devices may be used throughout the medical center. For example, both patient monitors and telemetry devices may be able to read the tags, so either can quickly identify its location using the tags. Bedsides may even include multiple tags, and a medical practitioner may select the tag appropriate for the patient's condition.

The medical monitoring device may include a wireless reader to read an identifier from a tag. The tag may be active or passive (e.g., the tag may be powered or may not need a power source other than wireless power received from the reader). The tag may be a radio frequency identification (RFID) tag (e.g., a near field communication (NFC) tag), a barcode (e.g., a one dimensional or two dimensional barcode), text, and/or the like. Thus, the wireless reader may be a radio frequency (RF) reader, a barcode reader (e.g., a laser scanner, a very small camera, etc.), a camera, and/or the like. Other electromagnetic and non-electromagnetic methods of or spectrums for wirelessly communicating information will be apparent to those of skill in the art. The medical monitoring device may be configured with multiple wireless readers for reading different kinds of tags. In some embodiments, a user may be able to select which wireless reader to use each time an identifier is read and/or select a setting indicating which wireless reader to use each time.

The tag and/or medical monitoring device may be configured to only work over very short distances. Accordingly, medical practitioners may need to hold the medical monitoring device close to the tag for the tag to be read and inadvertent tag reading may be unlikely. The tags may be located close to where the medical monitoring device will be mounted or hung to make reading tags convenient despite the short range. In some embodiments, the medical monitoring device may read the tag in response to a user input. In some embodiments, the user may specify which type of tag should be read, or the type of tag may have previous been set. Alternatively, or in addition, the medical monitoring device may periodically attempt to read any nearby tags (e.g., after a fixed time period has elapsed, each time the medical monitoring device is restarted or a sensor is added or removed, etc.). In some embodiments, the medical monitoring device may attempt to read multiple types of tags or the type of tag may have previously been set.

The medical monitoring device may determine its location based on the identifier. For example, the identifier may include an indication of the location, or the medical monitoring device may be able to look up the location based on the identifier. The medical monitoring device may look up a location corresponding to the identifier from a local storage device and/or may connect to a network to retrieve the location corresponding to the identifier. For example, a centralized database may maintain records of the location of each tag, and the medical monitoring device may query the centralized database when a tag is encountered. The centralized database may return the location in response to the query.

The medical monitoring device may change one or more settings based on the location (e.g., location specific configuration settings). The medical monitoring device may read the one or more settings from the tag and/or may look up settings corresponding to the identifier and/or location. The settings corresponding to the identifier and/or location may be stored locally and/or may be retrieved from a network. In some embodiments, the medical monitor device may send an identifier for itself in addition to the identifier from the tag to the network. The settings from the network may be formatted and/or selected for the particular medical monitoring device requesting them.

The settings may include network settings, such as an internet protocol (IP) address for the medical monitoring device, an IP address for a printer, network connection information, and/or the like. The settings may indicate data recipients. The data recipients may be central stations, viewports, patient records, or other destinations to which the measured physiological data should be sent. The settings may include alarm settings for one or more physiological parameters. The settings may include acuity settings and/or display settings affecting the visual arrangement and display of physiological parameters.

Some settings may be determined by the medical center, such as network settings, data recipients, alarm settings, and/or the like, and other settings may be specified by medical practitioners (e.g., doctors or nurses) in the particular ward, such as alarm settings, acuity and display settings, and/or the like. Settings may be selected based on the types of conditions expected for patients in a particular ward. The settings may be default settings that can be changed by a medical practitioner depending on the precise needs of a patient.

A server may determine the location of the various settings and retrieve them for the medical monitoring device in some embodiments. Various divisions of labor between servers and central stations are envisioned. The central stations may include all configuration information, and the server may simply determine which central station to associate with the medical monitoring device. Alternatively, or in addition, the server may hold some or all of the configuration information for the medical monitoring device. The settings associated with a particular bed and/or room may be updated remotely by changing the associated settings saved in a server accessible location and/or in the server. The medical monitoring device may receive updated settings the next time it reads an identifier, and/or the updated settings may be pushed to devices needing the updates (e.g., as determined based on their identifiers). Alternatively, or in addition, the tags may be updated or replaced to change the settings.

Central stations may also be configured based on the identifier provided to the network by the medical monitoring device. For example, an identifier provided by a medical monitoring device may be transmitted to a central station to which data will be provided. The central station may be aware of which patient is in each bed and/or room. The central station may associate the data received from the medical monitoring device with the patient in the same bed and/or room. The central station may display measurement data from the medical monitoring device next to the patient's name or other identifying information, and/or data and/or statistical information may be saved to the patient's medical record. Medical monitoring devices may also be tracked based on their reported locations, so the medical monitoring devices may be easily located for repairs, upgrades, and/or the like.

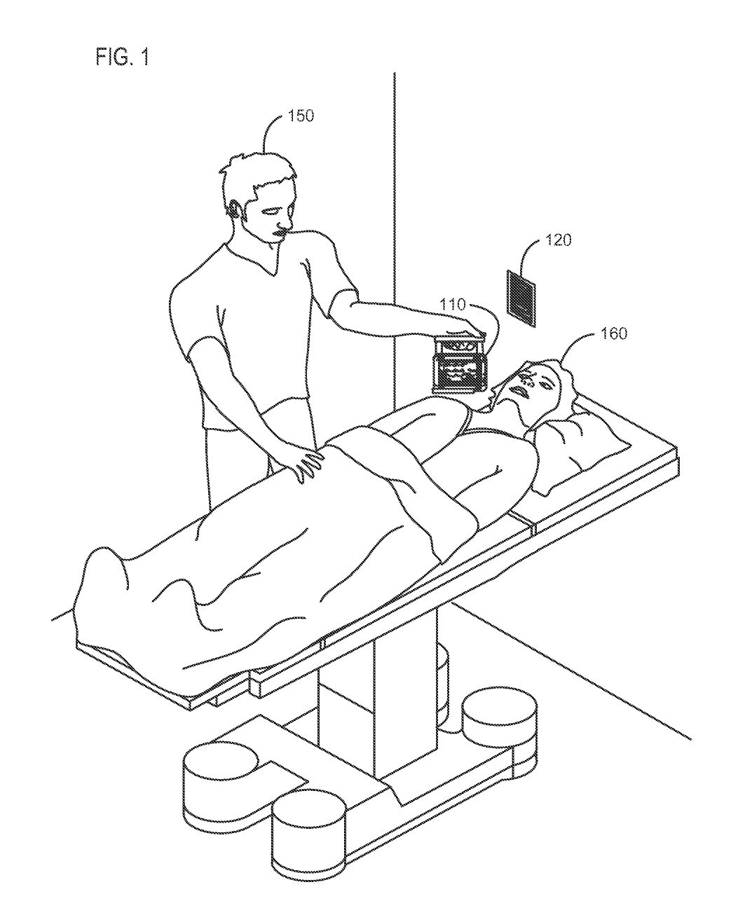

FIG. 1 is a perspective view of a medical practitioner 150 reading a tag 120 using a patient monitor 110. The patient monitor 110 may be connected to a patient 160 and may be measuring one or more physiological parameters of the patient. The patient 160 may have been recently transported to her current location along with the patient monitor 110. For example, the patient 160 may have recently received a diagnosis and/or triage classification indicating the patient 160 should go to her current location. Because the patient monitor 110 has just arrived at the bedside, it may include settings from another ward and/or default settings not associated with any ward. The patient monitor 110 also may not know which central station should receive physiological parameter data associated with the patient.

The illustrated wireless tag 120 may be an unpowered, RF tag. The tag 120 may store an identifier that is unique to this particular tag 120. The patient monitor 110 may receive an indication from the medical practitioner 150 that it should read the tag 120. The patient monitor 110 may transmit RF energy to the tag 120 to energize the tag 120. The tag 120 may use the received energy to read its identifier and transmit the identifier back to the patient monitor 110. The patient monitor 110 may use the identifier to determine a central station associated with the bed, configuration settings, and/or the like (e.g., by accessing a local or remote database). In some embodiments, the tag 120 may include an address for the central station and/or configuration settings for the patient monitor 110 in addition to, or instead of, the identifier. The medical practitioner 150 may be able to entirely configure the patient monitor simply by reading the wireless tag 120. The medical practitioner 150 can then make any special changes to the settings that he deems necessary.

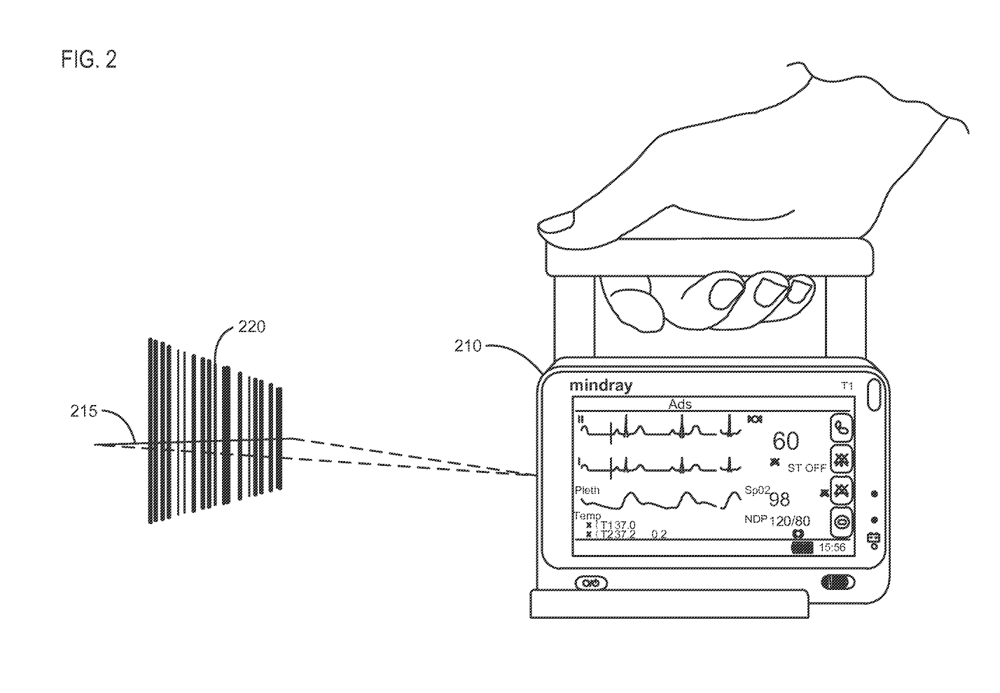

FIG. 2 is a perspective view of an alternate embodiment of a patient monitor 210 configured to read a tag 220. In this embodiment, the tag 220 may include a barcode. For example, the tag 220 may include paper and/or an adhesive onto which the barcode has been printed. The tag 220 may inexpensive to produce and unobtrusive once installed. In the illustrated embodiment, the patient monitor 210 projects a laser 215 onto the tag 220 to read the barcode (e.g., by reading the reflections with a photodiode). In other embodiments, the patient monitor 210 may use a small camera to read the tag 220 and may use image processing techniques to decipher the barcode. The patient monitor 210 may only be configured to read barcodes or may be configured to read RFID tags and barcodes. Various combinations of wireless readers are contemplated.

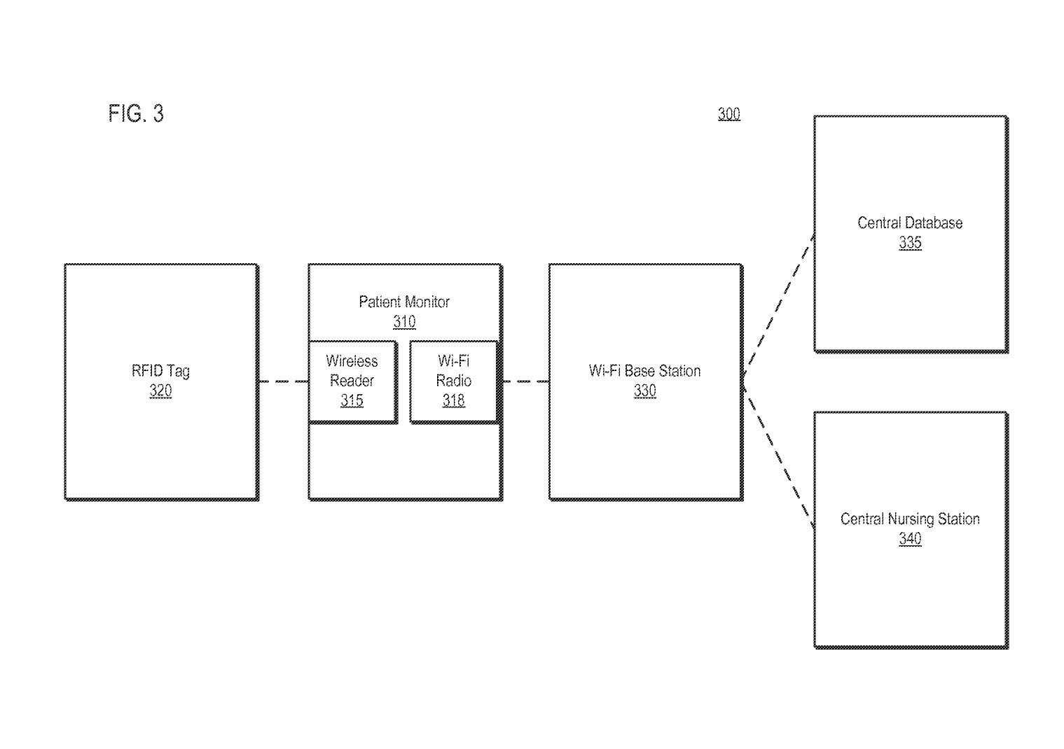

FIG. 3 is a block diagram of a system 300 for configuring a patient monitor 310 based on location. The patient monitor 310 may include a wireless reader 315 that is able to read an RFID tag 320. The RFID tag 320 may store an identifier that is read by the wireless reader 315. The identifier may be unique to the RFID tag 320 but may otherwise not include any information content. Alternatively, or in addition, the RFID tag 320 may include information content, such as a room number, indication of bed, settings for the patient monitor 310, an address from settings can be retrieved, and/or the like. The wireless reader 315 may transmit RF power to the RFID tag 320. The RFID tag 320 may use the wireless power to read the identifier from local storage and to transmit the identifier to the wireless reader 315. The wireless reader 315 may receive the identifier from the RFID tag 320 and provide it to the patient monitor 310.

The patient monitor 310 may include a Wi-Fi radio 318 able to wirelessly communicatively couple with a Wi-Fi base station 330. Wired or wireless communication methods other than Wi-Fi may be used in alternate embodiments. In the illustrated embodiment, the patient monitor 310 may not include local storage that associates the identifier with information of interest to the patient monitor 310 (e.g., location, patient information, settings, etc.). Instead, the patient monitor 310 may send the identifier to a central database 335, which may store the information of interest and associate it with identifiers from RFID tags. The central database 335 may look up the identifier and return any associated information to the patient monitor 310. The patient monitor 310 may adjust its settings and/or configuration based on the information received from the central database 335. To change the information associated with a particular identifier, the central database 335 can be updated, and any future requests from patient monitors will receive the updated information.

The settings stored by the central database 335 may include a destination for data from the patient monitor 310. For example, the settings received by the patient monitor 310 may indicate that the patient data should be sent to a central nursing station 340. The patient monitor 310 may use the Wi-Fi radio 318 and Wi-Fi base station 330 to transmit physiological data from the patient to the central nursing station 340. The patient monitor 310 may also indicate the location and/or patient identity to the central nursing station 340 based on the information received from the central database 335. In some embodiments, the central nursing station 340 may provide information associated with the identifier to the patient monitor 310 instead of, or in addition to, the central database 335.

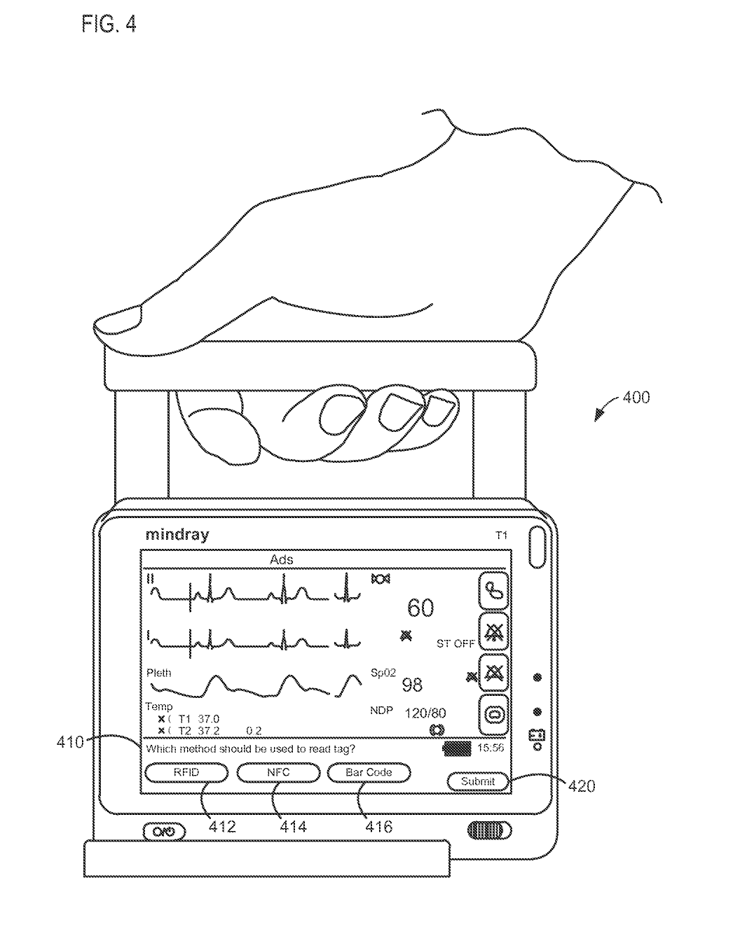

FIG. 4 is a perspective view of a patient monitor 400 presenting an exemplary screen display that may be provided to a user for selecting a wireless reader to read a tag. The patient monitor 400 may include a touch screen display that is able to display information to the user as well as receive inputs from the user. In other embodiments, other user interface outputs and inputs may be used to interact with the user. In the illustrated embodiment, the patient monitor 400 may include a plurality of wireless readers able to read different kinds of tags. Rather than attempt to read a tag using all possible wireless readers, the patient monitor 400 may display a prompt 410 asking the user which method to use to read the tag. The prompt 410 may be displayed in response to a user indication that the patient monitor 400 should attempt to read a tag.

The prompt 410 may allow the user to choose between using an RFID option 412, an NFC option 414, and a barcode option 416. The user may select a desired option 412, 414, 416 and press a submit button 420 to indicate that the option has been selected. The patient monitor 400 may select the appropriate wireless reader and/or appropriate wireless reader configuration for reading the tag based on the user input. Alternatively, or in addition, the patient monitor 400 may include settings specifying which wireless reader to use and/or the patient monitor 400 may remember a previous user selection. The patient monitor 400 may default to the wireless reader specified in the settings until the settings are changed. If the patient monitor 400 includes only a single kind of wireless reader, the patient monitor 400 may not need to prompt the user.

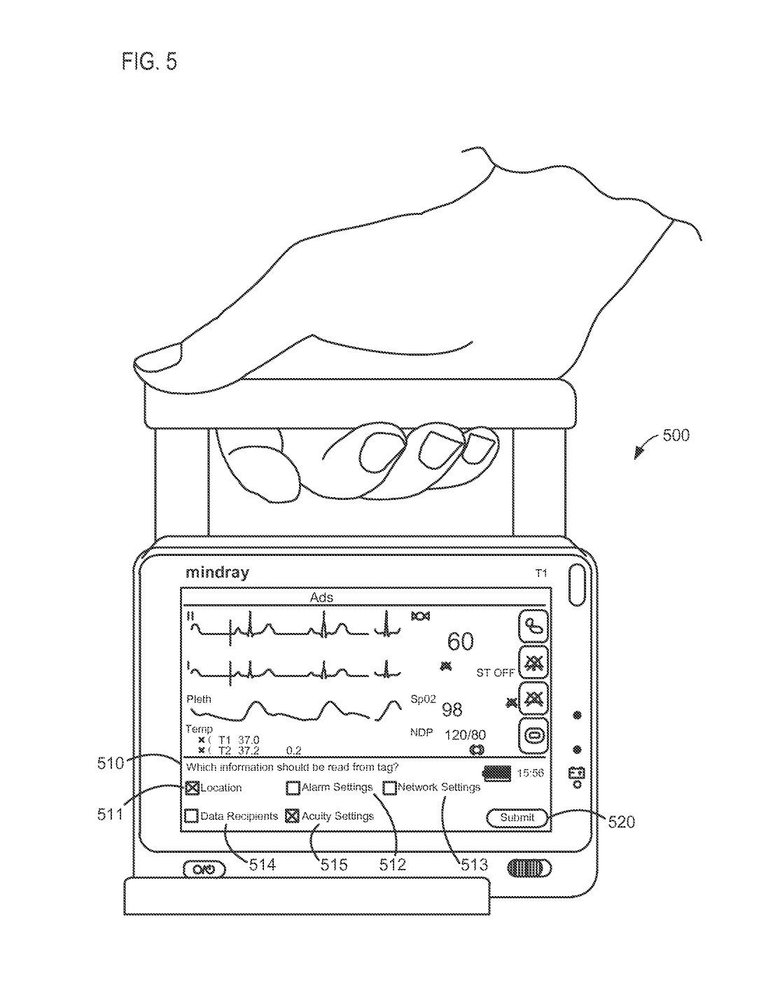

FIG. 5 is a perspective view of a patient monitor 500 presenting an exemplary screen display that may be provided to a user for selecting which information should be retrieved. The patient monitor 500 may present a prompt 510 asking which information should be read from the tag. The patient monitor 500 may prompt the user about information that is on the tag itself or may prompt the user about information that will be requested from a network once the tag is read. The tag reading process may be transparent to the user, so the user may not be aware of whether the information is coming from the tag or is coming from remote devices that the patient monitor can access via the network.

In the illustrated embodiment, the user may select between reading one or more of the following settings: location 511, alarm settings 512, network settings 513, data recipients 514, and/or acuity settings 515. The location 511 may be the location of the tag and may include a room number, indication of bed, a ward, a digital address (e.g., an IP address) the patient monitor 500 should use, and/or the like. The alarm settings 512 include upper and/or lower boundaries for one or more physiological parameters outside of which an alarm should be sounded and/or more complicated criteria. The alarm settings 512 may also indicate how the alarm should be signaled (e.g., locally, at a nursing station, etc.). The network settings 513 may include IP addresses and/or identification information for, e.g., printers, wireless routers, central databases, etc. The data recipients 514 may be destinations to which physiological data from the patient should be sent. The data recipients may include central stations, viewports, patient records, and/or the like. The frequency with which data should be transmitted may also be provided to the patient monitor 500. The acuity settings 515 may include adjustments to the layout of the display, the size of displayed data, the number of data parameters displayed, etc. The user may be able to select more than one type of information to read at once.

Once the user has selected the information to be retrieved, the user may press a submit button 520 to indicate that the desired selection has been made. The patient monitor 500 may read the settings from the tag and/or network. The patient monitor 500 may update its settings and/or configuration based on the received information. The loaded information may be loaded as default settings, and the user may be able to change the settings to fit the individual needs of the patient. Thus, the user may choose to load a particular set of information if only a few or no changes will be made to the information or may not load the information if the user prefers to enter it entirely by hand.

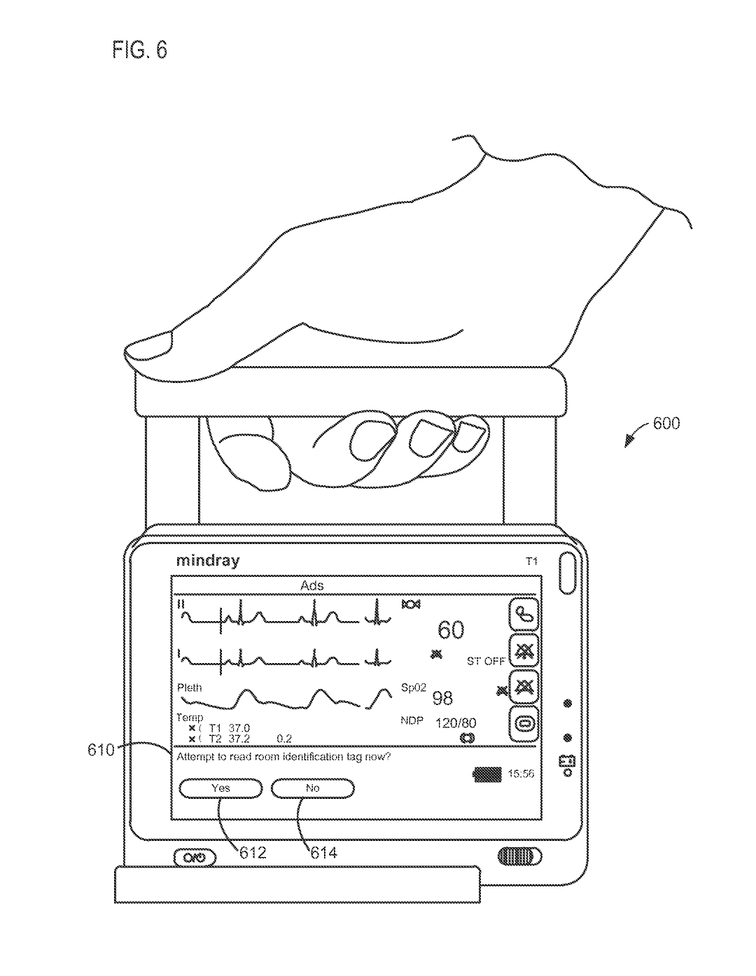

FIG. 6 is a perspective view of a patient monitor 600 presenting an exemplary screen display confirming that a tag should be read. To conserve energy, the patient monitor 600 may confirm that the user is ready and that the tag is nearby before attempting to read the tag. For example, the patient monitor 600 may display a prompt 610 asking whether it should read the identification tag now. The patient monitor 600 may provide a yes option 612 and a no option 614. The patient monitor 600 may immediately attempt to read the tag in response to an input selecting the yes option 612 and may abort the attempt to read in response to the no option 614.

In other embodiments or configurations, the patient monitor 600 may not prompt the user. For example, the patient monitor 600 may periodically attempt to read any nearby tags and/or may attempt to read nearby tags after predetermined events (e.g., powering on, waking from a rest state, etc.). The patient monitor 600 may determine whether the identifier is new and/or centrally stored information associated with the identifier has been updated. The patient monitor 600 may prompt the user after the tag is read to determine whether the user wants to use the newly discovered settings. In some embodiments, the patient monitor 600 may switch between receiving user requests to read tags and periodically reading tags (e.g., the settings may specify which mode, the patient monitor 600 may select a mode based on whether external power is connected, the patient monitor 600 may periodically attempt to read tags but allow user requests between attempts, etc.).

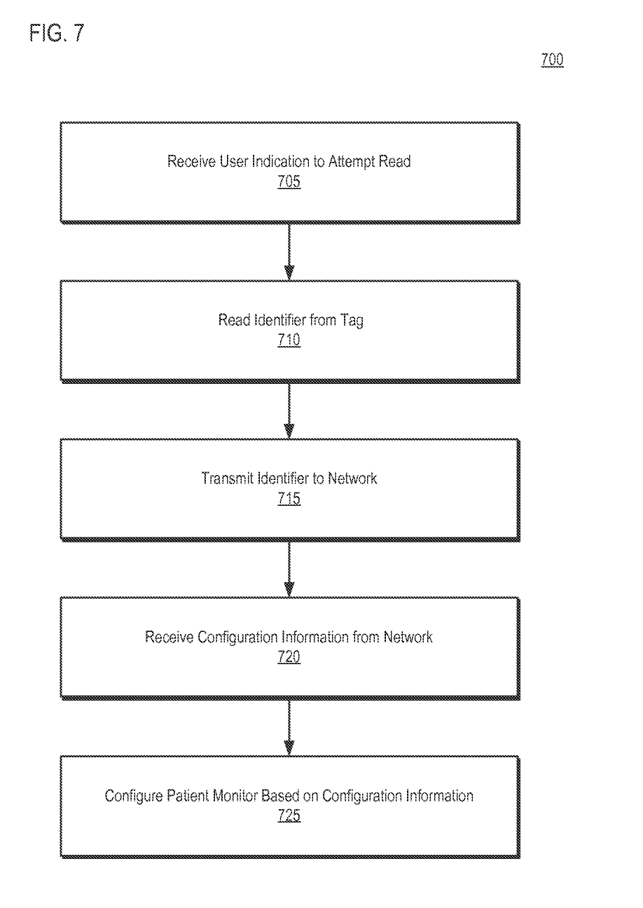

FIG. 7 is a flow diagram of a method 700 for discovering a location of a medical monitoring device. The method 700 may begin by receiving 705 a user indication to attempt to read a tag. Receiving 705 the user indication may include receiving indications of which type of tag should be read, what types of information should be read, confirmation that a read should be attempted, and/or the like. Receiving 705 the user indication may include a user indicating that reads should be attempted periodically and/or in response to predetermined events.

An identifier may be read 710 from the tag. Reading 710 the tag may include delivering energy to the tag, such as RF energy to an RFID tag or laser light to a barcode. The tag may use the energy to determine an identifier (e.g., an RFID tag may read the identifier from local storage, a barcode may absorb or reflect the energy based on the identifier, etc.). The tag may then transmit the identifier back. The identifier may be read when it is transmitted from the tag. The identifier may be encoded (e.g., with error correction), so reading 710 the tag may include decoding the identifier in some embodiments.

The identifier may be transmitted 715 to a network. For example, the identifier may be transmitted 715 over a wireless communicative coupling to a medical center intranet. Depending on the embodiment, the identifier may be transmitted 715 to a server, a central database, a central nursing station, a viewport, and/or the like. The network may automatically determine the destination for identifiers, and/or medical monitoring devices may be configured to know the destination. Alternatively, or in addition, the identifier may include the desired location, and/or the desired destination may be read from the tag in addition to the identifier.

The ultimate destination for the identifier may include a storage device that stores information (e.g., configuration information) in association with identifiers. The identifier may be used to look up the associated configured information, which may be returned via the network. Transmitting 715 the identifier may include indicating which information should be returned. The requested information may be received 720 from the network. The requested information may include configuration information, which may modify the operation of medical monitoring devices. For example, the information may include settings (e.g., alarm settings, network settings, acuity settings, etc.), data recipients, and/or the like. The information may also, or instead, identify the location of the tag and/or a patient assigned to that bed and/or room.

A medical monitoring device, such as a patient monitor, may be configured 725 based on the received configuration information. For example, patient monitor settings may be modified based on the configuration information. In an embodiment, the configuration information may include values for various settings, and the patient monitor may replace its own settings values with the ones received. The configuration information may also include destinations for physiological data measured by the patient monitor. The patient monitor may begin using the updated configuration settings and transmitting to the indicated destinations immediately after receiving the configuration information. Alternatively, or in addition, the patient monitor may alert the user to the changes being made and/or confirm with the user that the changes may be made. The configuration information may include default settings and destinations that can be updated by a user. The patient monitor may use identifying information (e.g., for the location and/or patient) when communicating with data recipients to indicate a source for the data and/or a location or patient with whom the data should be associated.

Embodiments may include various steps, which may be embodied in machine-executable instructions to be executed by a computer system. A computer system includes one or more general-purpose or special-purpose computers (or other electronic devices). The computer system may include hardware components that include specific logic for performing the steps or may include a combination of hardware, software, and/or firmware.

Embodiments may also be provided as a computer program product including a computer-readable medium having stored thereon instructions that may be used to program a computer system or other electronic device to perform the processes described herein. The computer-readable medium may include, but is not limited to: hard drives, floppy diskettes, optical disks, CD ROMs, DVD ROMs, ROMs, RAMs, EPROMs, EEPROMs, magnetic or optical cards, solid-state memory devices, or other types of media/computer-readable media suitable for storing electronic instructions.

Computer systems and the computers in a computer system may be connected via a network. Suitable networks for configuration and/or use as described herein include one or more local area networks, wide area networks, metropolitan area networks, and/or “Internet” or IP networks, such as the World Wide Web, a private Internet, a secure Internet, a value-added network, a virtual private network, an extranet, an intranet, or even standalone machines which communicate with other machines by physical transport of media (a so-called “sneakernet”). In particular, a suitable network may be formed from parts or entireties of two or more other networks, including networks using disparate hardware and network communication technologies.

One suitable network includes a server and several clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

The network may include communications or networking software, such as the software available from Novell, Microsoft, Artisoft, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” or wireless protocols known to those of skill in the art. The network may encompass smaller networks and/or be connectable to other networks through a gateway or similar mechanism.

Each computer system includes at least a processor and a memory; computer systems may also include various input devices and/or output devices. The processor may include a general purpose device, such as an Intel®, AMD®, or other “off-the-shelf” microprocessor. The processor may include a special purpose processing device, such as an ASIC, SoC, SiP, FPGA, PAL, PLA, FPLA, PLD, or other customized or programmable device. The memory may include static RAM, dynamic RAM, flash memory, one or more flip-flops, ROM, CD-ROM, disk, tape, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computer systems may be capable of using a floppy drive, tape drive, optical drive, magneto-optical drive, or other means to read a storage medium. A suitable storage medium includes a magnetic, optical, or other computer-readable storage device having a specific physical configuration. Suitable storage devices include floppy disks, hard disks, tape, CD-ROMs, DVDs, PROMs, random access memory, flash memory, and other computer system storage devices. The physical configuration represents data and instructions which cause the computer system to operate in a specific and predefined manner as described herein.

Suitable software to assist in implementing the invention is readily provided by those of skill in the pertinent art(s) using the teachings presented here and programming languages and tools, such as Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Several aspects of the embodiments described will be illustrated as software modules or components. As used herein, a software module or component may include any type of computer instruction or computer executable code located within a memory device. A software module may, for instance, include one or more physical or logical blocks of computer instructions, which may be organized as a routine, program, object, component, data structure, etc., that perform one or more tasks or implement particular abstract data types.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Much of the infrastructure that can be used according to the present invention is already available, such as: general purpose computers; computer programming tools and techniques; computer networks and networking technologies; digital storage media; authentication; access control; and other security tools and techniques provided by public keys, encryption, firewalls, and/or other means.

It will be understood by those having skill in the art that many changes may be made to the details of the above-described embodiments without departing from the underlying principles of the invention. The scope of the present disclosure should, therefore, be determined only by the following claims.

1. A medical monitoring device comprising:
a measurement component configured to receive, from at least one sensor, physiological data representative of a physiological condition of a patient;
a wireless reader configured to retrieve an identifier from a tag without mechanically coupling with the tag; and
a processing unit configured to determine a location associated with the identifier.

2. The medical monitoring device of claim 1, wherein the processing unit is configured to retrieve the location from a network using the identifier.

3. The medical monitoring device of claim 1, wherein the processing unit is configured to retrieve configuration information corresponding to the identifier from a network.

4. The medical monitoring device of claim 3, wherein the configuration information includes an indication of a central station to which data from the medical monitoring device should be provided.

5. The medical monitoring device of claim 1, wherein the identifier comprises the location.

6. The medical monitoring device of claim 1, wherein the identifier comprises alarm settings.

7. The medical monitoring device of claim 1, wherein the tag is selected from the group consisting of a radio frequency identification tag and a barcode.

8. The medical monitoring device of claim 1, wherein the wireless reader attempts to retrieve the identifier from the tag periodically.

9. A method for discovering a location of a medical monitoring device, the method comprising:
the medical monitoring device receiving a user indication to read a tag;
the medical monitoring device reading an identifier from the tag;
the medical monitoring device determining the location based on the identifier; and
the medical monitoring device adjusting a configuration of the medical monitoring device based on the location.

10. The method of claim 9, wherein determining the location comprises retrieving the location from a network using the identifier.

11. The method of claim 9, further comprising retrieving configuration information corresponding to the identifier from a network.

12. The method of claim 11, wherein the configuration information includes an indication of a central station to which data from the medical monitoring device should be provided.

13. The method of claim 9, wherein the identifier comprises the location.

14. The method of claim 9, wherein the identifier comprises alarm settings.

15. The method of claim 9, wherein the tag is selected from the group consisting of a radio frequency identification tag and a barcode.

16. The method of claim 9, wherein reading the identifier from the tag comprises attempting to retrieve the identifier from the tag periodically.

17. A system for providing locations to medical monitoring devices, the system comprising:
a tag comprising an identifier, wherein the tag is readable by a medical monitoring device, and wherein the tag is unassociated with a docking station;
a communication network configured to communicatively couple with the medical monitoring device; and
a storage device configured to associate the identifier with configuration information,
wherein the communication network is configured to receive the identifier from the medical monitoring device and return the associated configuration information to the medical monitoring device.

18. The system of claim 17, wherein the storage device is further configured to associate the identifier with a location, and wherein the communication network is further configured to return the associated location to the medical monitoring device.

19. The system of claim 17, wherein the configuration information includes an indication of a central station to which data from the medical monitoring device should be provided.

20. The system of claim 17, wherein the configuration information includes alarm settings.

21. The system of claim 17, wherein the tag is selected from the group consisting of a radio frequency identification tag and a barcode.
